(19) United States
(12) Patent Application Publication
(10) Pub. No.: US 2007/0179637 A1
(43) Pub. Date: Aug. 2, 2007

(54) Data access system

(75) Inventor: Yasunori Shirai, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/651,170

(22) Filed: Jan. 8, 2007

(30) Foreign Application Priority Data
Jan. 11, 2006 (JP) 2006-003422

(51) Int. Cl. G05B 11/01; G05B 13/02

(52) U.S. Cl. 700/28; 700/21

(57) ABSTRACT

A data access system includes: an external computer; and a control apparatus having a control-side control unit and a standby-side control unit, wherein the control-side control unit accepts a data reading request or a data writing request from the external computer, and returns a process result, the control-side control unit and the standby-side control unit hold equalized data, and each of the control-side control unit and the standby-side control unit includes: a communication processing section for processing communication with the external computer; and a data access processing section for executing a requested process by accessing the data.

This application claims foreign priority based on Japanese Patent application No. 2006-003422, filed Jan. 11, 2006, the content of which is incorporated herein by reference in its entirety.

### BACKGROUND OF THE INVENTION

1. Field of the Invention

The present invention relates to a data access system including an external computer and a control apparatus having a control-side control unit and a standby-side control unit, wherein the control-side control unit accepts a data reading request or a data writing request from the external computer, and returns a process result, and the control-side control unit and the standby-side control unit hold equalized data.

2. Description of the Related Art

There is a data access system which accepts a data reading request or a data writing request from an external computer, and which returns a process result. FIG. 4 is a functional block diagram showing a configuration example of a data access system of a related art.

In FIG. 4, reference numeral 1 denotes an operation monitoring apparatus of a distributed control system, which is connected to a control bus 2. Reference numeral 3 denotes a control apparatus which is realized by a programmable logic controller (PLC) or the like. The control apparatus is connected to the control bus 2 to communicate with the operation monitoring apparatus 1 and control equipments of a plant.

The control apparatus 3 has control units 4 and 5 which are duplexed. The control-side control unit 4 has a data area 41, and an access processing section 42 for accessing the data area to process data reading or data writing. Similarly, the standby-side control unit 5 has a data area 51, and an access processing section 52 for accessing the data area to process data reading or data writing.

The control-side control unit 4 of the control apparatus 3 executes a control while communicating with the equipments 7 of the plant via a field bus 6. The control-side control unit 4 also directly communicates with equipments such as a valve 8 and a sensor 9. Information of the equipments to be controlled are collected in the data area 41 of the control-side control unit 4. Although not illustrated, the data in the data area 51 of the standby-side control unit 5 are equalized with the data in the data area 41 by equivalent communication.

The reference numeral 10 denotes an external computer connected to the control bus 2. An application 11 for abnormality diagnosis and the like is implemented on the external computer 10. When a data reading or a data writing access request is transmitted from the external computer 10 to the control apparatus 3, the access processing section 42 of the control-side control unit 4 accesses the data area 41, and returns the process result to the external computer 10.

In a case where such a data access processing is to be executed, in order to ensure the simultaneity of control between the control-side control unit and the standby-side control unit, every time when the access processing section 42 of the control-side control unit 4 communicates with the external computer 10, the access processing section 42 of the control-side control unit 4 and the access processing section 52 of the standby-side control unit 5 perform synchronous communication, so that the same access is executed also in the access processing section 52 of the standby-side control unit 5 in an apparently simultaneous manner.

FIG. 5 is a diagram illustrating the sequence of the reading process. The access processing section 42 of the control-side control unit 4 accepts a reading request including a designated address from the external computer 10, and accesses the data area 41 to execute the reading process. Then, the access processing section 42 notifies the access processing section 52 of the standby-side control unit 5 of the completion of the reading process.

When the access processing section 52 of the standby-side control unit 5 receives the notification of reading completion, the access processing section 42 of the control-side control unit 4 and the access processing section 52 of the standby-side control unit 5 execute the synchronous communication. After the synchronous communication, the access processing section 42 of the control-side control unit 4 transmits a reply frame having the read data to the external computer 10, and the external computer 10 acquires the requested data.

FIG. 6 is a diagram illustrating the sequence of the writing process. The access processing section 42 of the control-side control unit 4 accepts a data writing request from the external computer 10, and receives writing data including a designated address. The writing data are notified to the access processing section 52 of the standby-side control unit 5, and a reply frame is created.

When the access processing section 52 of the standby-side control unit 5 receives the writing data, the access processing section 42 of the control-side control unit 4 and the access processing section 52 of the standby-side control unit 5 execute the synchronous communication. After the synchronous communication, the access processing section 42 of the control-side control unit 4 and the access processing section 52 of the standby-side control unit 5 simultaneously access the corresponding addresses of the data areas 41 and 51 to execute the writing process.

After the simultaneous writing process is completed, the access processing section 42 of the control-side control unit 4 transmits the reply frame to the external computer 10, and the external computer 10 receives the execution result of the requested writing.

JP-A-6-230995 discloses a duplex processor apparatus which equalizes the contents of program execution memories of a control-side processor device and a standby-side processor device.

The related data access system has the following problems.

(1) In the communication for the reading process, in order to make the process identical with the communication for the writing process, the synchronous communication is executed between the control-side and standby-side control units for every communication. In the standby-side control unit 5, however, the access to the data area 51 is not executed, and hence it is useless to execute the synchronous communication. In order to execute this process, the control-side and standby-side control units perform waste communication. This results in increases of the CPU load and the communication load.

(2) In the writing communication, the control-side and standby-side control units simultaneously perform the writing process, so that the wiring process is executed after both control units mutually perform the synchronous communication. A processing program for the synchronous communication/writing is created for each of functions in which duplex should be considered by being integrated with the communication processing, in each of the access processing sections 42 and 52. Accordingly, programs are different for each communication mode, so that the programs have no versatility, and have poor reusability.

### SUMMARY OF THE INVENTION

The present invention has been made in view of the above circumstances, and provides a data access system in which synchronous communication in a reading process is eliminated to reduce a CPU load, and a writing process uses a standardized data access processing function to enhance the reusability of programs.

In some implementations, a data access system of the invention comprising:

an external computer; and

a control apparatus having a control-side control unit and a standby-side control unit,

wherein the control-side control unit accepts a data reading request or a data writing request from the external computer, and returns a process result,

the control-side control unit and the standby-side control unit hold equalized data, and

each of the control-side control unit and the standby-side control unit includes:

a communication processing section for processing communication with the external computer; and

a data access processing section for executing a requested process by accessing the data.

In the data access system, the data access processing sections of the control-side control unit and the standby-side control unit mutually perform synchronous communication for a simultaneous writing process, in response to the data writing request from the external computer.

In the data access system, in response to the data reading request from the external computer, the control apparatus executes a process of the data reading request process only in the control-side control unit.

In the data access system, in response to the data reading request from the external computer, the communication processing section of the control-side control unit directly executes a process of the data reading request, not by way of the data access processing section.

In the data access system, the data access processing section is implemented by a generalized program.

In the data access system, the communication processing section is customized in accordance with a communication mode with the external computer.

In the data access system, the control apparatus is a programmable logic controller.

### BRIEF DESCRIPTION OF THE DRAWINGS

FIG. 1 is a functional block diagram showing an embodiment of a data access system to which the invention is applied.

FIG. 2 is a diagram illustrating the sequence of a reading process of FIG. 1.

FIG. 3 is a diagram illustrating the sequence of a writing process of FIG. 1.

FIG. 4 is a functional block diagram showing a configuration example of a data access system of a related art.

FIG. 5 is a diagram illustrating the sequence of a reading process of FIG. 4.

FIG. 6 is a diagram illustrating the sequence of a writing process of FIG. 4.

### DESCRIPTION OF THE PREFERRED EMBODIMENTS

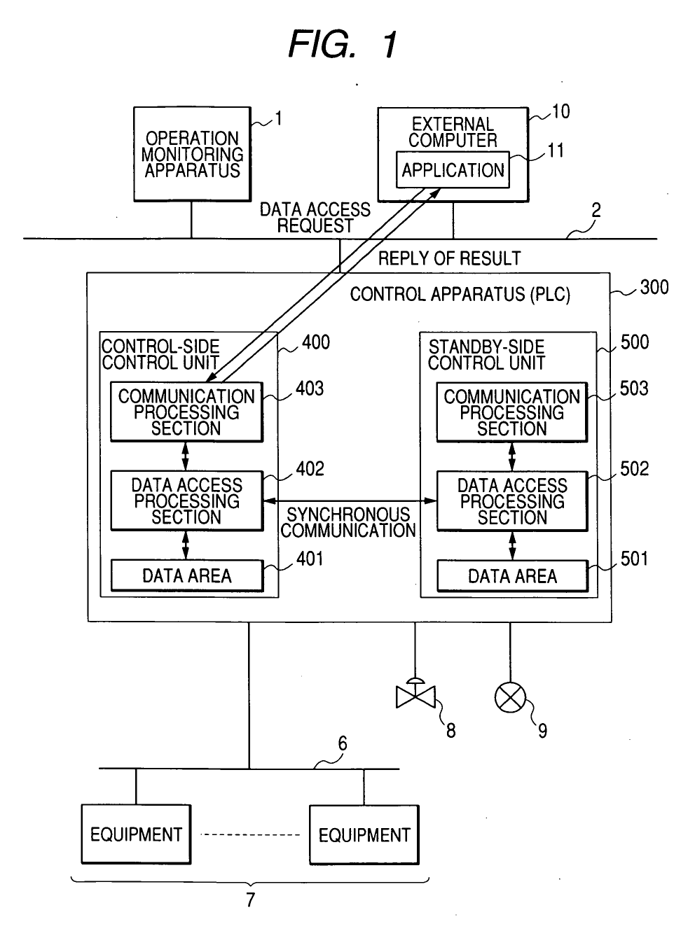

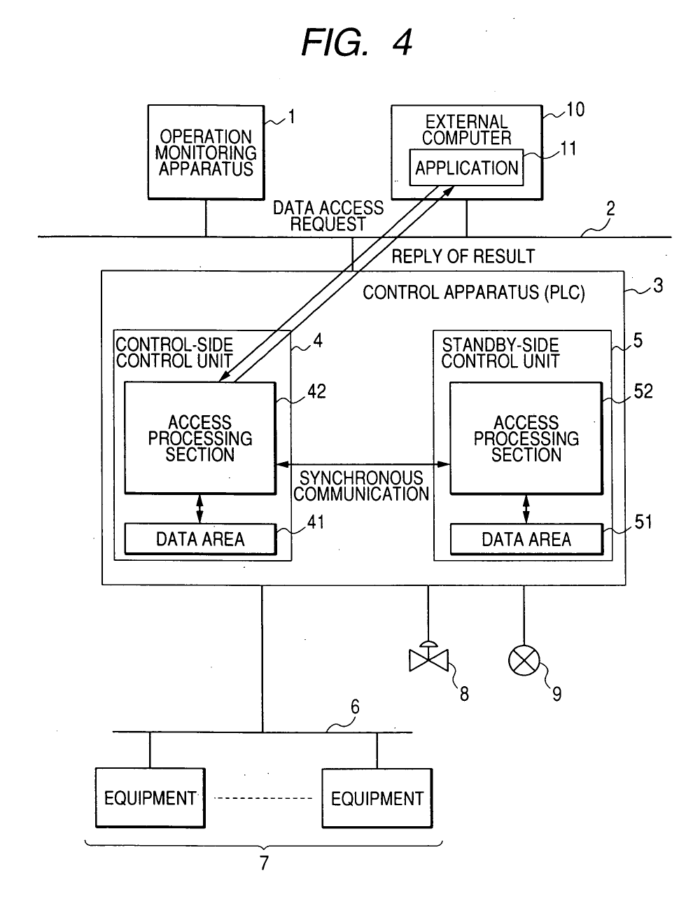

Hereinafter, the invention will be described in detail with reference to the accompanying drawings. FIG. 1 is a functional block diagram showing an embodiment of a data access system to which the invention is applied. The components identical with those of the related system which has been described with reference to FIG. 4 are denoted by the same reference numerals, and their description is omitted.

Referring to FIG. 1, reference numeral 300 denotes a control apparatus to which the invention is applied. The fundamental function of the control apparatus is identical with that of the control apparatus 3 of the related system. Reference numeral 400 denotes a control-side control unit, and reference numeral 500 denotes a standby-side control unit.

In the control-side control unit 400, reference numeral 401 denotes a data area, and reference numeral 402 denotes a data access processing section implemented by standard programs. The data access processing section is specialized to the access to the data area 401, and has versatility. As the programs, a standardized package software which has been already developed can be utilized.

The reference numeral 403 denotes a communication processing section which is specialized to execute a communication processing with the external computer 10. The reading/writing access with respect to the data area 401 is requested to the data access processing section 402, and the communication processing section acquires a result of the access.

The communication processing section 403 is customized so as to adopt communication protocols in accordance with the communication mode with the external computer 10 by, for example, the control bus depending on the specification of the manufacturer, versatile Modbus/TCP, Ethernet (registered trademark), etc.

Functions of a data area 501, a data access processing section 502 and a communication processing section 503 in the standby-side control unit 500 are identical with those of the corresponding components 401, 402, and 403 of the control-side control unit 400.

When an access request from the external computer 10 is a data writing request, the data access processing section 402 of the control-side control unit 400 and the data access processing section 502 of the standby-side control unit 500 execute the transmission/reception of writing data and the synchronous communication.

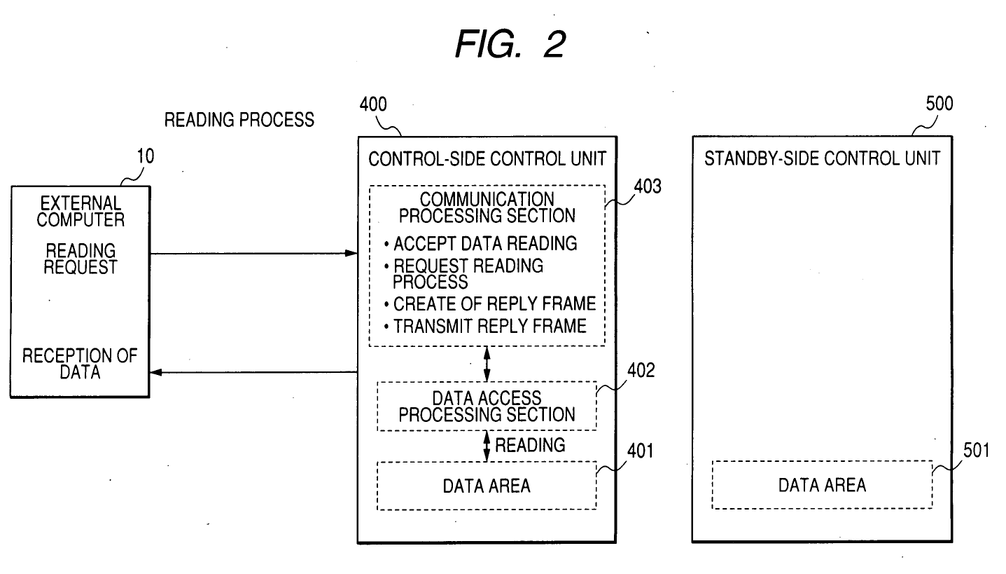

FIG. 2 is a diagram illustrating the sequence of the reading process. The communication processing section 403 of the control-side control unit 400 accepts a reading request including a designated address from the external computer 10, requests the data access processing section 402 to perform the reading process with respect to the data area 401, and creates a reply frame.

The data access processing section 402 accesses the data area 401 to execute the requested reading process, and returns the read data to the communication processing section 403. The communication processing section 403 transmits the reply frame including the data to the external computer 10. The external computer 10 acquires the requested data.

In the present invention, for a reading request from the external computer 10, the reading request process is executed only by the process of the control-side control unit 400, and the synchronous communication with respect to the standby-side control unit 500 is not executed. Accordingly, the standby-side control unit 500 is not concerned in the reading process.

As for the process of the reading request from the external computer 10, alternatively, the communication processing section 403 of the control-side control unit 400 may directly execute the reading process from the data area 401, not by way of the data access processing section 402.

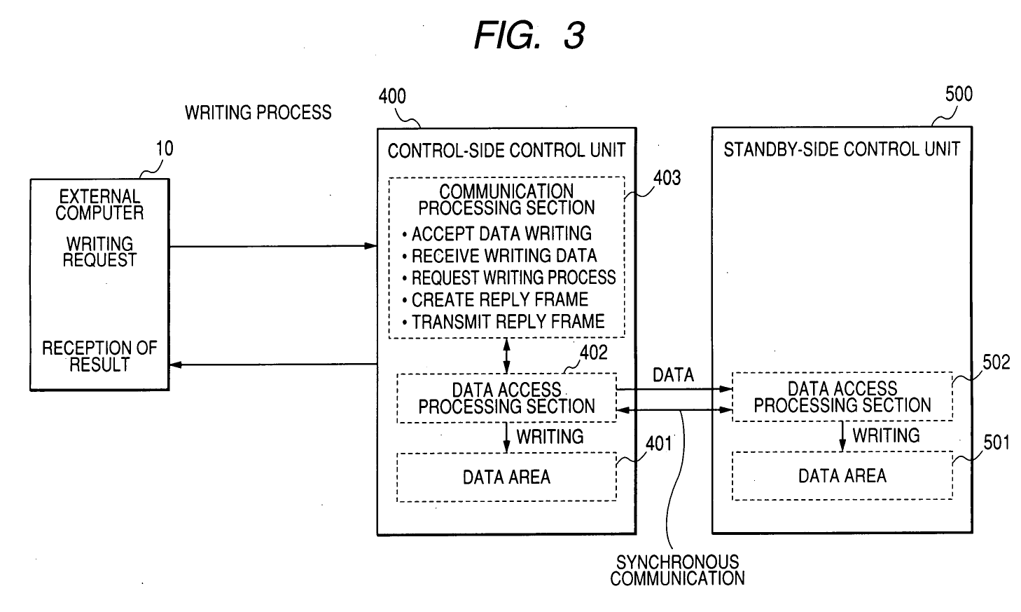

FIG. 3 is a diagram illustrating the sequence of the writing process. When the communication processing section 403 of the control-side control unit 400 accepts a data writing request from the external computer 10 and receives writing data, the communication processing section 403 requests the data access processing section 402 to perform the writing process to the data area 401, and then creates a reply frame.

The data access processing section 402 which is requested to perform the writing process transmits the writing data to the data access processing section 502 of the standby-side control unit 500. After the transmission is completed, the synchronous communication is executed, and simultaneous writing with a designated address is executed on the respective data areas 401 and 501.

After the simultaneous writing is completed, the data access processing section 402 notifies the communication processing section 403 of the completion of the writing process. When the communication processing section 403 receives the notification, the communication processing section 403 transmits the reply frame to the external computer 10, and the external computer 10 receives an execution result of the requested writing.

In the embodiment, the duplex system provided with one standby-side control unit 500 has been described. However, the invention can be applied also to a multiplex system provided with two or more standby-side control units.

As the external computer 10, an independent computer connected to the control bus 2 is exemplarily shown. Alternatively, the external computer may be configured in such a manner that application 11 is implemented in the operation monitoring apparatus 1. Alternatively, the external computer 10 may be located in a remote place and connected via a generalized communication bus which can communicate with the control bus 2.

As the control apparatus 300 which controls the equipments of the plant, the PLC is exemplarily shown. However, the control apparatus is not limited to this example. The control apparatus may be a control apparatus of a usual distributed control system, or a safety control apparatus in a safety system.

As apparent from the above description, according to the invention, the following effects can be attained.

(1) As for the data reading, the synchronous communication between the control-side and standby-side control units is not required in the reading process, so that the CPU load is reduced.

(2) As for the data writing, processing programs for writing in data areas of the control-side and standby-side control units are created respectively for every function in the related art. According to the data access system of the invention, the programs are handed over to the standardized data access processing sections. Therefore, it is not necessary to create programs individually.

(3) The functions of the communication processing section that is customized correspondingly to the communication mode and of the standardized data access processing section are separated. Therefore, the processing structure in the data writing process is simplified, and hence the CPU load and the communication load in the writing process are reduced.

(4) The introduction of the standardized data access processing section can improve the reusability of the software structure and the software quality due to the reusability. Thus, it is possible to contribute to the reduction in the number of development processes of the system.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

### FIG. 1

1 OPERATION MONITORING APPARATUS
7 EQUIPMENT
10 EXTERNAL COMPUTER
11 APPLICATION
300 CONTROL APPARATUS (PLC)
400 CONTROL-SIDE CONTROL UNIT
401, 501 DATA AREA
402, 502 DATA ACCESS PROCESSING SECTION
403, 503 COMMUNICATION PROCESSING SECTION
500 STANDBY-SIDE CONTROL UNIT
a DATA ACCESS REQUEST
b REPLY OF RESULT
c SYNCHRONOUS COMMUNICATION

### FIG. 2

10 EXTERNAL COMPUTER
400 CONTROL-SIDE CONTROL UNIT
401 DATA AREA
402 DATA ACCESS PROCESSING SECTION
403 COMMUNICATION PROCESSING SECTION
   ACCEPT DATA READING
   REQUEST READING PROCESS
   CREATE OF REPLY FRAME
   TRANSMIT REPLY FRAME
500 STANDBY-SIDE CONTROL UNIT
501 DATA AREA
a READING PROCESS
b READING
c READING REQUEST
d RECEPTION OF DATA

### FIG. 3

10 EXTERNAL COMPUTER
400 CONTROL-SIDE CONTROL UNIT
401 DATA AREA
402 DATA ACCESS PROCESSING SECTION
403 COMMUNICATION PROCESSING SECTION
   ACCEPT DATA WRITING
   RECEIVE WRITING DATA
   REQUEST WRITING PROCESS
   CREATE REPLY FRAME
   TRANSMIT REPLY FRAME
500 STANDBY-SIDE CONTROL UNIT
501 DATA AREA
502 DATA ACCESS PROCESSING SECTION
a WRITING PROCESS
b DATA
c SYNCHRONOUS COMMUNICATION
d WRITING
e WRITING REQUEST
f RECEPTION OF RESULT

### FIG. 4

1 OPERATION MONITORING APPARATUS
7 EQUIPMENT
10 EXTERNAL COMPUTER
11 APPLICATION
3 CONTROL APPARATUS (PLC)
4 CONTROL-SIDE CONTROL UNIT
41, 51 DATA AREA
42, 52 ACCESS PROCESSING SECTION
5 STANDBY-SIDE CONTROL UNIT
a DATA ACCESS REQUEST
b REPLY OF RESULT
c SYNCHRONOUS COMMUNICATION

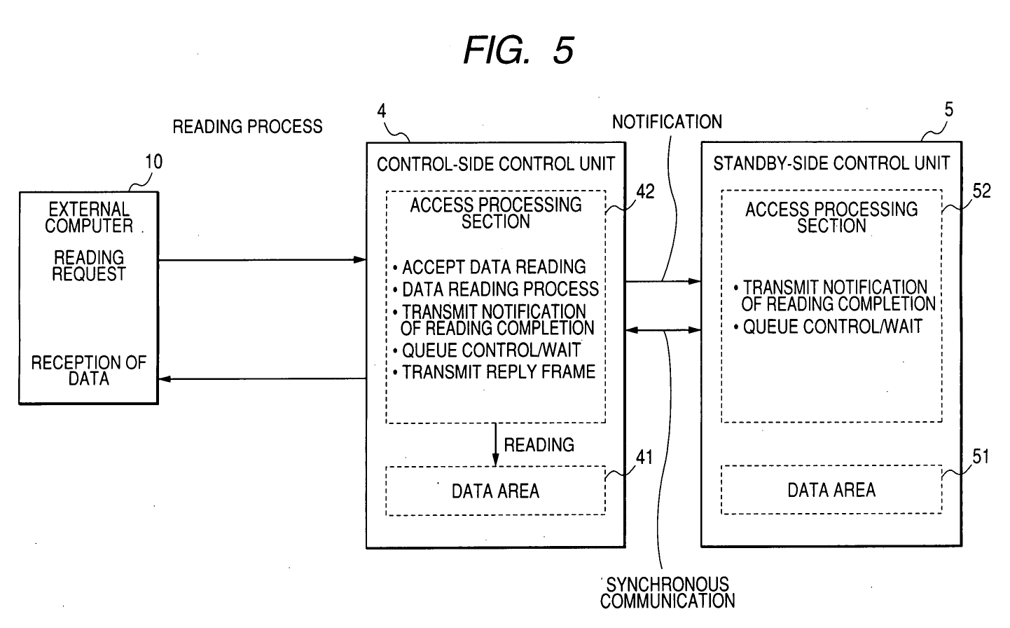

### FIG. 5

4 CONTROL-SIDE CONTROL UNIT
5 STANDBY-SIDE CONTROL UNIT
10 EXTERNAL COMPUTER
41 DATA AREA
42 ACCESS PROCESSING SECTION
   ACCEPT DATA READING
   DATA READING PROCESS
   TRANSMIT NOTIFICATION OF READING COMPLETION
   QUEUE CONTROL/WAIT
   TRANSMIT REPLY FRAME
51 DATA AREA
52 ACCESS PROCESSING SECTION
   TRANSMIT NOTIFICATION OF READING COMPLETION
   QUEUE CONTROL/WAIT
a READING PROCESS
b NOTIFICATION
c READING
d SYNCHRONOUS COMMUNICATION
e READING REQUEST
f RECEPTION OF DATA

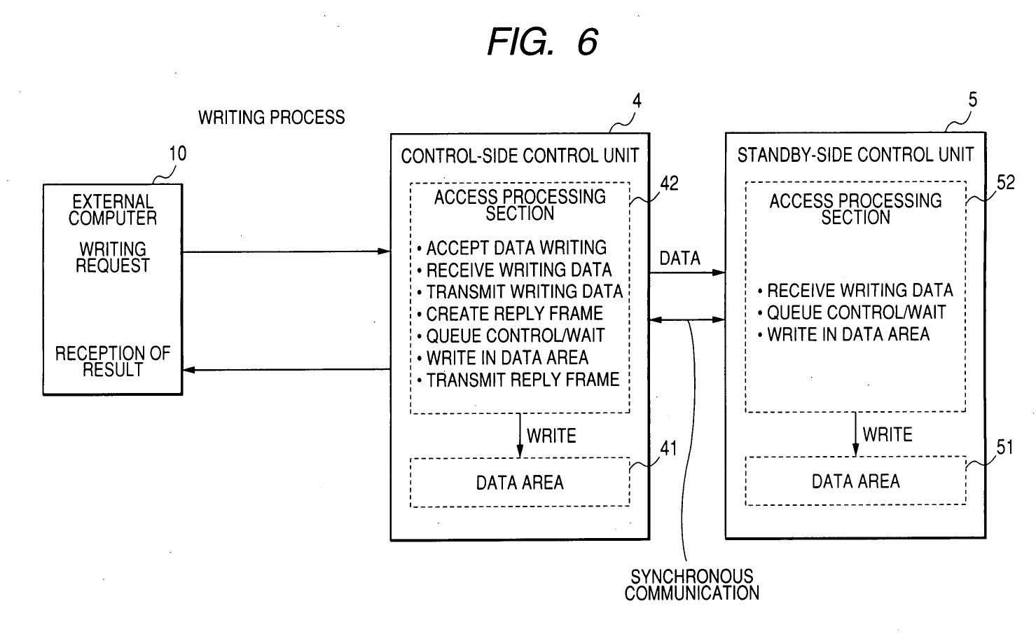

### FIG. 6

4 CONTROL-SIDE CONTROL UNIT
5 STANDBY-SIDE CONTROL UNIT
10 EXTERNAL COMPUTER
41 DATA AREA
42 ACCESS PROCESSING SECTION
   ACCEPT DATA WRITING
   RECEIVE WRITING DATA
   TRANSMIT WRITING DATA
   CREATE REPLY FRAME
   QUEUE CONTROL/WAIT
   WRITE IN DATA AREA
   TRANSMIT REPLY FRAME
51 DATA AREA
52 ACCESS PROCESSING SECTION
   RECEIVE WRITING DATA
   QUEUE CONTROL/WAIT
   WRITE IN DATA AREA
a WRITING PROCESS
b DATA
c WRITE
d SYNCHRONOUS COMMUNICATION
e WRITING REQUEST
f RECEPTION OF RESULT

What is claimed is:

1. A data access system comprising:
an external computer; and
a control apparatus having a control-side control unit and a standby-side control unit,
wherein the control-side control unit accepts a data reading request or a data writing request from the external computer, and returns a process result,
the control-side control unit and the standby-side control unit hold equalized data, and
each of the control-side control unit and the standby-side control unit includes:
a communication processing section for processing communication with the external computer; and
a data access processing section for executing a requested process by accessing the data.

2. The data access system according to claim 1, wherein the data access processing sections of the control-side control unit and the standby-side control unit mutually perform synchronous communication for a simultaneous writing process, in response to the data writing request from the external computer.

3. The data access system according to claim 1, wherein in response to the data reading request from the external computer, the control apparatus executes a process of the data reading request process only in the control-side control unit.

4. The data access system according to claim 2, wherein in response to the data reading request from the external computer, the control apparatus executes a process of the data reading request process only in the control-side control unit.

5. The data access system according to claim 1, wherein in response to the data reading request from the external computer, the communication processing section of the control-side control unit directly executes a process of the data reading request, not by way of the data access processing section.

6. The data access system according to claim 2, wherein in response to the data reading request from the external computer, the communication processing section of the control-side control unit directly executes a process of the data reading request, not by way of the data access processing section.

7. The data access system according to claim 3, wherein in response to the data reading request from the external computer, the communication processing section of the control-side control unit directly executes the process of the data reading request, not by way of the data access processing section.

8. The data access system according to claim 1, wherein the data access processing section is implemented by a generalized program.

9. The data access system according to claim 2, wherein the data access processing section is implemented by a generalized program.

10. The data access system according to claim 3, wherein the data access processing section is implemented by a generalized program.

11. The data access system according to claim 1, wherein the communication processing section is customized in accordance with a communication mode with the external computer.

12. The data access system according to claim 2, wherein the communication processing section is customized in accordance with a communication mode with the external computer.

13. The data access system according to claim 3, wherein the communication processing section is customized in accordance with a communication mode with the external computer.

14. The data access system according to claim 1, wherein the control apparatus is a programmable logic controller.

15. The data access system according to claim 2, wherein the control apparatus is a programmable logic controller.

16. The data access system according to claim 3, wherein the control apparatus is a programmable logic controller.
